(19) United States
(12) Patent Application Publication
(10) Pub. No.: US 2004/0025298 A1
(43) Pub. Date: Feb. 12, 2004

(54) Elevation angle adjustment mechanism of display

(75) Inventors: Gordon Yang, Taipei (TW); Alex Ling, Taipei (TW)

Correspondence Address: BROWDY AND NEIMARK, P.L.L.C., 624 NINTH STREET, NW, SUITE 300, WASHINGTON, DC, 20001-5303, US

(73) Assignee: ELITEGROUP COMPUTER SYSTEMS CO., LTD, Taipei (TW)

(21) Appl. No.: 10/212,270

(22) Filed: Aug. 6, 2002

(51) Int. Cl. E05D 11/08

(52) U.S. Cl. 16/340

(57) ABSTRACT

An automatic homing rotary hinge, which includes a pivotal rod, a spring slipped onto the pivotal rod, an assembly board, and a friction portion. The friction portion has a spacer, a baffle, a push gasket, and a skidproof gasket, which are assembled on the pivotal rod in order. Static balance is achieved between a torsion of the spring, the weight of an object and an elastic pressing force and a friction force of the friction portion to arbitrarily position the included angle between two objects. The spring is used to restore the original included angle between the two objects.

### FIELD OF THE INVENTION

The present invention relates to an automatic homing rotary hinge, which is connected between two objects to provide rotation, positioning, and automatic homing functions for them.

### BACKGROUND OF THE INVENTION

Generally speaking, many PC peripherals require connection structures for connection, rotation, and positioning. The most common one is a pivot structure connected between a display and a host computer for providing the functions of adjusting and positioning angle to achieve comfortable and convenient use. Therefore, how to design a pivot structure of stable positioning, convenient use, and rigidity is a very important issue.

As shown in FIGS. 1 and 2, a conventional pivot structure comprises a pivot 10a, an assembly board 20a, and an elastic pressing unit 30a. A small-diameter rod 11a of the pivot 10a is used to assemble the assembly board 20a and the elastic pressing unit 30a, and a screw nut 35a is locked thereon. The elastic pressing unit 30a comprises a gasket 31a, a leftward projective elastic sheet 32a, a rightward projective elastic sheet 33a, and a slab spacer 34a. The gasket 31a and the assembly board 20a are pivotally connected on the small-diameter rod 11a to facilitate rotation thereon. The leftward projective elastic sheet 32a and the rightward projective elastic sheet 33a are against each other to deform for generating elastic pressing tension and retaining resistance, thereby restricting the assembly board 20a to rotate on the small-diameter rod 11a of the pivot 10a.

However, the above conventional rotary hinge utilizing elastic deformation of the projective elastic sheets 32a and 33a to restrict the assembly board 20a to rotate on the small-diameter rod 11a of the pivot 10a has the following drawbacks.

1. In order to stop relative motion between the pivot 10a and the assembly board 20a, the conventional rotary hinge utilizes elastic deformation of the projective elastic sheets 32a and 33a to restrict the assembly board 20a to rotate on the small-diameter rod 11a of the pivot 10a. However, an already adjusted angle may easily change because of the weight of an object locked on the rotary hinge, resulting in inconvenience in use.

2. The projective elastic sheets 32a and 33a of the conventional rotary pivot may easily be fatigued due to many times of use, and lose the torsion for stopping relative motion between the pivot 10a and the assembly board 20a.

3. The conventional rotary hinge has no automatic homing function. A user must spend much effect to open or close the two objects connected thereon, resulting in inconvenience in use.

Accordingly, the present invention aims to provide an automatic homing rotary hinge to resolve the problems in the prior art.

### SUMMARY OF THE INVENTION

One object of the present invention is to provide an automatic homing rotary hinge, which is assembled between two objects to let them have automatic homing function.

Another object of the present invention is to provide an automatic homing rotary hinge assembled between two objects. Static balance between the weight of one of the two object and an elastic pressing force and a friction force of the automatic homing rotary hinge is exploited to arbitrarily position the included angle between the two objects.

Another object of the present invention is to provide a slow automatic homing rotary hinge having the same effect as an oil press so as to avoid impact between two objects assembled on the automatic homing rotary hinge due to the weight of one of the two objects and thus overcome the drawback of easy destruction of the two objects when they are closed.

Another object of the present invention is to provide an automatic homing rotary hinge. Static balance between the weight of one object and the automatic homing rotary hinge is exploited to achieve positioning effect between two objects. The lifetime of use of a push gasket thereof can thus be lengthened.

To achieve the above objects, the present invention provides an automatic homing rotary hinge, which comprises a pivotal rod, a spring assembled on the pivotal rod, an assembly board, and a friction portion. The pivotal rod and the assembly board are locked between two objects to adjust the included angle between them. The friction portion comprises a spacer, a baffle, a push gasket, and a skidproof gasket, which are assembled on a small-diameter rod in order. A screw nut is locked onto the small-diameter rod. Degree of deformation of the push gasket abutting against the baffle is adjusted to generate different elastic pressing forces and friction forces, thereby changing the magnitude of friction force between the spacer, a guide plate of the assembly board, and the baffle to provide a torsion for stopping relative motion between the pivotal rod and the assembly board. Static balance between the spring, the weight of one of the two objects, and action forces of the friction portion is exploited to arbitrarily position the included angle between the two objects. Moreover, the spring is used to restore the original included angle between the two objects.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of a conventional rotary hinge;

FIG. 2 is a cross-sectional view of a conventional rotary hinge;

FIG. 3 is an exploded perspective view of an automatic homing rotary hinge of the present invention;

FIG. 4 is a perspective assembly view of an angle adjustment device of the present invention;

FIG. 5 is a side view of an angle adjustment device of the present invention assembled between two objects; and

FIG. 6 is another side view of an angle adjustment device of the present invention assembled between two objects.

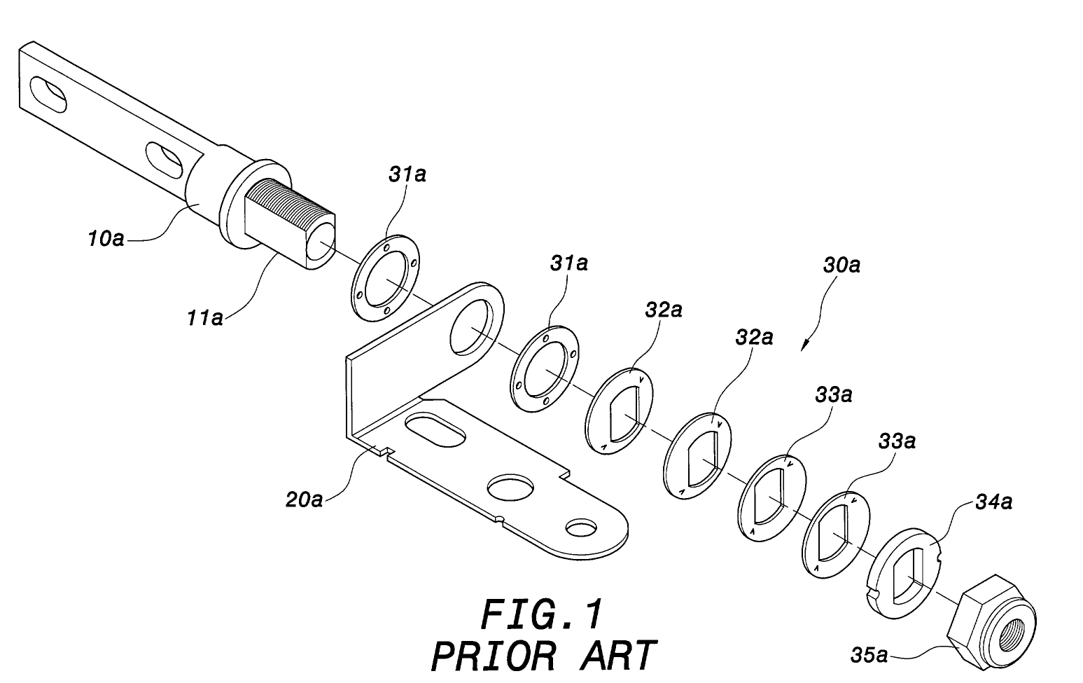

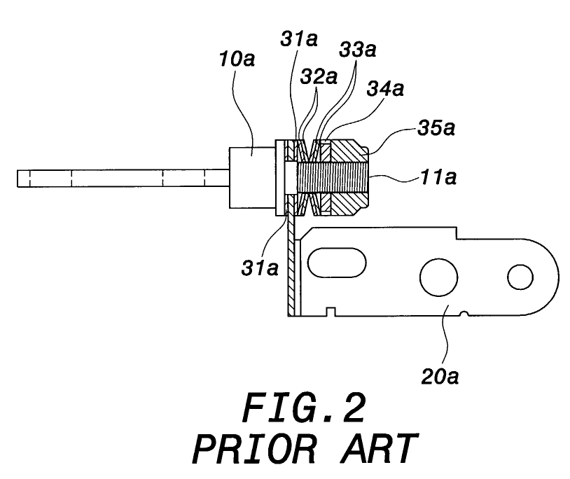

### DETAILED DESCRIPTION OF THE PREFERRED EMBODIMENT

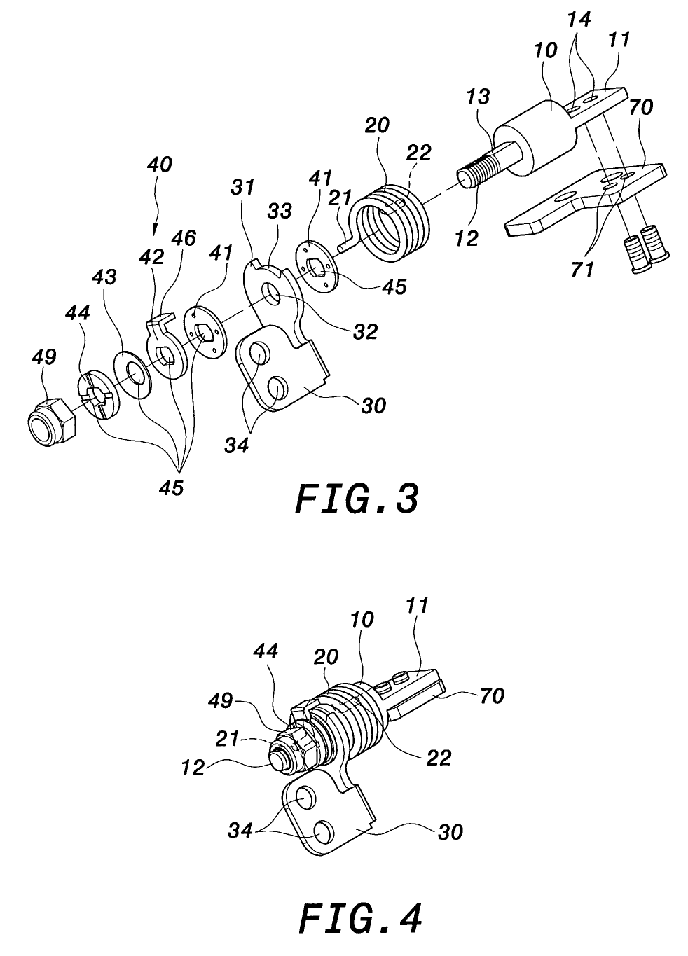

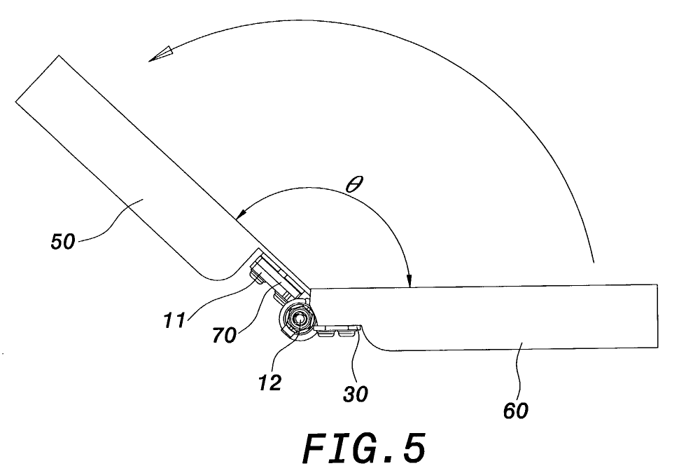

As shown in FIG. 3, an automatic homing rotary hinge of the present invention comprises a pivotal rod 10, a spring 20 slipped onto the pivotal rod 10, an assembly board 30, and a friction portion 40. The pivotal rod 10 and the assembly board 30 are locked onto a first object 50 and a second object 60 (shown in FIG. 5), and are used to adjust the included angle between the two objects 50 and 60.

As shown in FIGS. 3 and 4, a slab 11 projects from the front end face of the pivotal rod 10, and a small-diameter rod 12 projects from the rear end face of the pivotal rod 10. Planes 13 are formed at upper and lower sides of the pivotal rod 10. The spring 20 can be a torsion spring, and has a first arm 21 and a second arm 22. One side of the assembly board 30 is bent to form a guide plate 31. A pivotal hole 32 and a locking portion 33 are formed on the guide plate 31. The small-diameter rod 12 passes through the pivotal hole 32 to assemble the assembly board 30 onto the small-diameter rod 12. The assembly board 30 is assembled behind the spring 20. A first circular hole 34 is formed on the assembly board 30 so that the second object 60 can be locked onto the assembly board 30, as shown in FIG. 5.

As shown in FIG. 3, the friction portion 40 comprises a spacer 41, a baffle 42, a push gasket 43, and a skidproof gasket 44, each of which has a through hole 45. The through holes 45 of the spacer 41, the baffle 42, the push gasket 43, and the skidproof gasket 44 correspond to the cross section of the small-diameter rod 12. The spacer 41, the baffle 42, the push gasket 43, and the skidproof gasket 44 are slipped onto the small-diameter rod 12 in order, and are assembled behind the assembly board 30. Finally, a screw nut 49 is locked onto the small-diameter rod 12. Another spacer 41 is assembled between the spring 20 and the assembly board 30. Elasticity of the screw nut 49 locked onto the small-diameter rod 12 can be adjusted to force the push gasket 43 to abut against the baffle 42. Deformation of the push gasket 43 generates an elastic pressing force and a friction force to adjust the magnitude of the friction force between the spacer 41, the guide plate 31 of the assembly board 30, and the baffle 42, thereby providing a torsion for stopping relative motion between the pivotal rod 10 and the assembly board 30. Besides, a projective portion 46 is disposed on the baffle 42, and is locked onto the locking portion 33 of the guide plate 31 to limit the rotation angle of the assembly board 30 on the small-diameter rod 12.

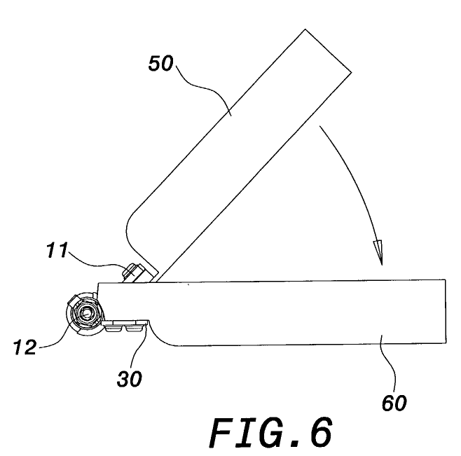

As shown in FIG. 4, the slab 11 of the pivotal rod 10 has a first screw hole 14 locked with a fixing sheet 70. The fixing sheet 70 has a second circular hole 71 locked with the second object 60 (shown in FIG. 5). The first arm 21 and the second arm 22 of the spring 20 slipped onto the pivotal rod 10 abut against the side face of the assembly board 30 and the upper end face of the fixing sheet 70, respectively. A torsion is applied onto the spring 20 beforehand to let it have a restoring force. When the direction of the weight of the first object 50 is opposite to that of the torsion of the spring 20 (shown in FIG. 5), static balance is achieved between the weight of the first object 50 and the torsion of the spring 20 and the friction force and the elastic pressing force of the friction portion 40, hence positioning the included angle between the first object 50 and the second object 60 to an angle of θ. When the weight of the first object 50 and the torsion of the spring 20 are in the same direction (shown in FIG. 6), in order to achieve static balance between the components assembled onto the pivotal rod 10, the automatic homing rotary hinge lets the first object 50 be closed on the second object 60. This is automatic homing function of the automatic homing rotary hinge. Moreover, the automatic homing rotary hinge also generates slow homing effect similar to an oil press due to the elastic pressing force and the friction force of the friction portion 40.

Besides, it is also feasible that the slab 11 of the pivotal rod 10 touches the first object 50 (shown in FIG. 6), and the second arm 22 of the spring 20 abuts against the slab 11 of the pivotal rod 10 (not shown).

To sum up, the automatic homing rotary hinge of the present invention can generate automatic homing effect. Through static balance between the automatic homing rotary hinge and the objects locked thereon, the included angle between the two objects can be arbitrarily positioned within a certain range. The lifetime of use of the skidproof gasket can also be lengthened. Moreover, the two objects are closed more slowly to avoid impact between them and thus overcome the drawback of easy destruction of the two objects.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An automatic homing rotary hinge, comprising:
a pivotal rod with a protruding small-diameter rod;
a spring slipped onto said pivotal rod;
an assembly board having a pivotal hole passed by said small-diameter rod;
a friction portion comprising a spacer, a baffle, a push gasket, and a skidproof gasket, each of which having a through hole, said through holes of said spacer, said baffle, said push gasket, and said skidproof gasket corresponding to the cross section of said small-diameter rod and being slipped onto said small-diameter rod in order, said spacer, said baffle, said push gasket, and said skidproof gasket being assembled behind said assembly board and being used to generate a friction force and an elastic pressing force and let said spring generate a torsion so as to have automatic homing function.

2. The automatic homing rotary hinge as claimed in claim 1, wherein said spring is a torsion spring.

3. The automatic homing rotary hinge as claimed in claim 1 further comprising a screw nut locked onto said small-diameter rod to lock said assembly board, said spring, and said friction portion onto said pivotal rod.

4. The automatic homing rotary hinge as claimed in claim 1 further comprising a slab protruding from said pivotal rod.

5. The automatic homing rotary hinge as claimed in claim 4 further comprising a fixing sheet locked onto said slab.

6. The automatic homing rotary hinge as claimed in claim 5 further comprising a plurality of circular holes, which are disposed on said fixing sheet and used to assemble said fixing sheet onto an object.
